(19) United States
(12) Patent Application Publication
(10) Pub. No.: US 2014/0041535 A1
(43) Pub. Date: Feb. 13, 2014

(54) TRASH COMPACTOR HAVING A LINEAR ACTUATOR

(71) Applicants: Nancy A. Shearer, Depew, NY (US); Andrew J. Shearer, Depew, NY (US)

(72) Inventors: Nancy A. Shearer, Depew, NY (US); Andrew J. Shearer, Depew, NY (US)

(21) Appl. No.: 13/572,127

(22) Filed: Aug. 10, 2012

(51) Int. Cl. B30B 15/00; B30B 9/00; B30B 13/00; B30B 1/32

(52) U.S. Cl. 100/35; 100/229 A; 100/99; 100/73; 100/102; 100/349; 100/100

(57) ABSTRACT

The present invention is a trash compactor having a housing, with a floor and upper support holding a linear actuator with a plunger and plate to crush trash and garbage in a receptacle supported on the floor of the housing. An electric motor is used to operate the linear actuator, preferably a DC powered electric motor. Hydraulic pumps or pneumatic device may also be used to move the linear actuator. A control panel with PLC capability controls the motor and other devices. An upper door allows for depositing of trash while an opposite lower door allows for the removal and replacement of the trash receptacles.

### FIELD OF THE INVENTION

The field of the invention relates generally to waste disposal, more particularly to trash compactors, and still more particularly to ram-type trash compactors.

### BACKGROUND OF THE INVENTION

Trash and waste generation, collection, and removal is a persistent problem in commercial and industrial milieus. In such environments as airports, malls, and commercial offices, for example, trash and garbage are usually deposited in a number of receptacles or containers by workers, visitors, and/or members of the general public after which it is removed and gathered in one or more collection points for removal.

At times, a business or commercial entity may utilize a compactor at a particular collection point to reduce the volume of trash ultimately removed from the facility. However, the overall system produces inefficiencies in that trash pickups often must be made from each of the several trash receptacles numerous times over the course of a work cycle and delivered separately to one or a few compactors. An advantage could be found in providing devices that compact the trash where the trash is actually deposited in that the trash container would hold more trash thereby requiring fewer removals per day or hour at the container site.

Another problem with many compactors is that they are often constructed to have the ram that compresses the trash laid out horizontally, that is parallel to the floor or ground. Consequently, the compactor occupies a great deal of floor or ground space, space that is often expensive and that could be used for other productive purposes. Often horizontal rams are used as they may be found to be easier to load than vertical rams, but this advantage is offset by the greater space occupied by a horizontal ram.

In addition, compactors with rams, including vertical rams, do not include accessible deposit doors that enable individuals to deposit small amounts of trash or garbage such as plastic coffee cups, napkins, plates, etc. Thus, the advantages of a compactor equipped with a vertical ram are not available for general use in public facilities such as, for example, airports, malls, and arenas.

Thus, there is a need in the field for a compactor with a vertical ram designed to include accessible trash deposit doors to receive trash and compact it at the deposit site.

### SUMMARY OF THE INVENTION

The present invention broadly comprises a trash compactor including a removable trash receptacle having an upper edge; a housing, the housing having a floor and a support that extends across and is supported by the housing, an inlet door located above the upper edge of the trash receptacle when the trash receptacle is positioned within the housing, and an outlet door sized to enable the trash receptacle to pass through the lower door. The trash compactor also includes a linear actuator secured to the support, the linear actuator comprising a plunger arranged for vertical translational movement: a plate secured to a distal end of the plunger and operatively arranged to compact trash within the trash receptacle; a device operatively arranged to power the linear actuator and impart a motive force to the plunger to move the plate within the receptacle; and, a control panel operatively arranged to control the device.

In an alternate embodiment, the present invention broadly comprises a trash compactor that includes a removable trash receptacle having an upper edge; a frame having a support extending across at least one upper edge of the outer frame; a linear actuator supported by the support and including a plunger and a plate attached to the plunger; a device operatively arranged to power the linear actuator and impart a vertical translational movement to the plunger to move the plate within the receptacle; and, a control panel operatively arranged to control the device.

The present invention also includes a method for compacting trash using a compactor that includes the steps of; positioning the removable trash receptacle in the housing under the linear actuator; lowering the device to move the plate into the receptacle in a downward vertical translational movement; measuring the distance the plate moves into the receptacle; spraying a wetting solution into the receptacle; and, raising the plate to a position above the upper edge of the receptacle in an upward translational movement.

An object of the invention is to provide a combined trash deposit bin and trash compactor that can be used to receive trash from individual users.

A second object of the invention is to present a trash deposit bin that can receive an increased amount of trash.

A third object of the invention is to supply a device suitable for use in public facilities that can both receive trash and be operated outside the view of the general public.

### BRIEF DESCRIPTION OF THE SEVERAL VIEWS OF THE DRAWINGS

The nature and mode of the operation of the present invention will now be more fully described in the following detailed description of the invention taken with the accompanying drawing FIGURES, in which:

FIG. 1A is a top view of the trash compactor of the present invention;

FIG. 1B is a schematic cross section of the trash compactor showing the placement of the trash receptacle within a frame;

FIG. 2 is a front view of the trash compactor depicting the surrounding housing and the trash deposit door;

FIG. 3 is a rear view of the trash compactor showing the outlet door located below the lower level of the opening for the inlet door on the opposing front side;

FIG. 4A is a top view of an alternate embodiment of the trash compactor of the present invention in which the housing completely encloses the compactor;

FIG. 4B is a schematic cross section of the alternate embodiment of compactor including the use of solar powered rechargeable batteries;

FIG. 5 is a front view of the compactor shown in FIG. 4B depicting an upper trash deposit door;

FIG. 6 is a rear view of the embodiment shown in FIG. 4B depicting an outlet door to receive and remove the trash receptacle;

FIG. 7 is a rear view of a second alternate embodiment of the trash compactor in which the trash receptacle is on wheels;

FIG. 8 is a side view of the compactor built into a wall showing a user depositing trash into the inlet door; and,

FIG. 9 is the same view as FIG. 8 showing an operator removing the trash receptacle from the outlet door.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

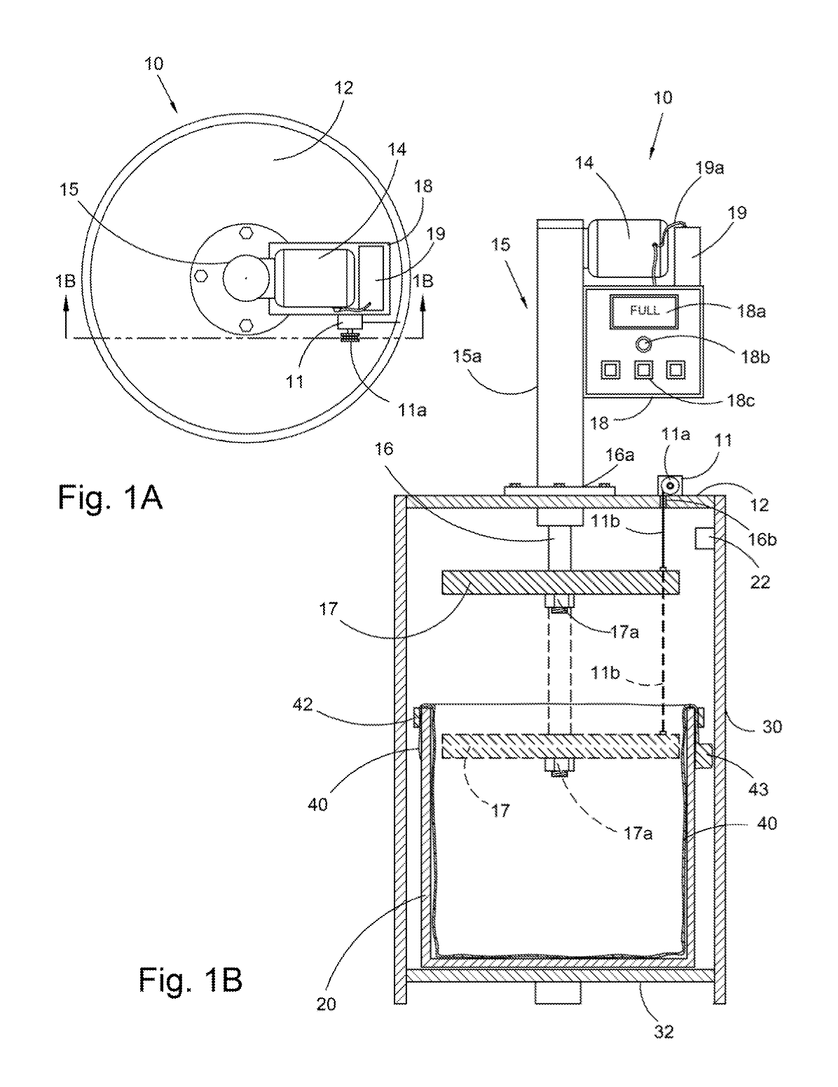

Adverting to the drawings, FIG. 1A is a top view of trash compactor 10 (“compactor 10”). Upper support 12 holds linear actuator 15 which includes plunger casing 15a within which plunger 16 (not seen in FIG. 1A) is housed, and plate 17, discussed below, which is attached to the end of plunger 16. Device 14 is operatively arranged to power linear actuator 15 and imparts a motive force to plunger 16. By operatively arranged it is meant that a component or device is connected either directly or indirectly to a second component and causes that second component to function. For example, as described above, device 14 is described as operatively arranged to power, i.e., impart a motive force to linear actuator 15 meaning device 14 causes plunger 16 in linear actuator 15 to move vertically up and down relative to upper support 12. Device 14 may be, for example, a hydraulic pump, a pneumatic actuator or, preferably, an electric motor with enough power to move plunger 16 to compact trash deposited into compactor 10. The use of electric motors removes the possibility of spills of hydraulic oil or ruptures of hydraulic lines.

In a preferred embodiment, linear actuator Model PA-17-22-850 from Progressive Automations, Richmond, BC, Canada can be used which is equipped with a 12 volt DC powered motor. Linear actuators may also be of the type manufactured by Exlar Corp of Chanhassen, Minn.. Alternate devices 14 are electric motors manufactured by Allen Bradley of Milwaukee, Wis.. Device 14, in this embodiment DC motor 14, can be powered by a variety of power supplies/sources 19. Motor 14 may be supplied power by standard 120/220 volt power lines with the alternate current optionally converted to direct current in a known manner. Alternatively, direct current (DC) powered motors 14 may utilize batteries 19, preferably rechargeable lithium-ion batteries 19 which provides the advantage of enabling the use of compactor 10 in stand-alone locations in which power lines are not readily available. In a second alternate embodiment, batteries 19 may be recharged using one or more solar panels (see below) such as in those systems manufactured by BigBelly Solar, Newton, Mass. which also enables compactor 10 to be placed in locations where power lines are not available. Control panel 18 is also powered by any one of the power sources 19 described above.

Preferably, control panel 18 is functionally attached to device 14 to control its actions. By functional attachment it is meant that the link(s) between control panel 18 and device 14 allows for control over the components through either a direct link, such as one or more cables and/or an indirect link such as a radio or wireless connection. Persons of skill in the art will recognize that simple power switches, for example, on/off switches, etc., may be used to control device 14.

FIG. 1B is a schematic cross section of compactor 10 depicting the placement of the trash receptacle 20 within frame 30. Frame 30 may be constructed from angle iron or, alternatively, 1 inch steel tubing, or other suitable materials known to persons having skill in the art. Guide hole 16a is defined by support 12 and receives plunger casing 15a to provide support for casing 15a and to ensure plunger 16 is moved accurately within compactor 10. Support 12 may be, but is not limited to, a cover over the top opening of frame 30 or a bar or steel tube that extends across two segments of the at least one upper edge of frame 30. Guide bars may be used, either in place of or as a supplement to, guide hole 16a, especially for larger plungers 16. Persons of skill in the art will recognize that, in an alternate embodiment, linear actuator 15 may not include casing 15a and that plunger 16 may be received by guide hole 16a without being housed in casing 15a. Plate 17 is attached to plunger 16 in a substantially perpendicular orientation using a nut 17a threadably attached to a threaded end of plunger 16. It will be recognized that plate 17 may be attached to plunger 16 by other suitable means such as, for example, welding, forging into an integral plunger-ram assembly, or a friction fit. In addition, although a perpendicular orientation is shown, persons of skill in the art will recognize that other orientations may be used to conform to specific shapes of receptacle 20. Also seen is liner 40 lining the inner wall of receptacle 20. Liner 40 may be held in place with flange 42 or may be an accordion liner held in place by weights attached to the upper edge of the liner to keep the liner in place as plate 17 moves into and out of receptacle 20 as shown by shaded plunger 16 and plate 17. One or more inlet doors to receive trash and outlet doors for removal of trash receptacle 20 may be attached to frame 30.

Optionally, liner 40 may include one or more pods or pouches 43 which contain a deodorizer and/or animal repellant. When liner 40 is removed from receptacle 20, pod 43 may be opened and the stored constituent(s) emptied into liner 40. A suitable deodorizer is m9™ deodorizer by Hollister Inc., Libertyville, Ill.

Preferably, plate 17 is sized to provide a close or snug fit within receptacle 20. Therefore, plate 17 may be preferably shaped, and sized to closely fit into rectangular, circular, square, or other shapes formed by the interior of receptacle 20.

FIG. 1B also depicts a distance measuring instrument 11, in this case potentiometer 11 supported by support 12. Potentiometer 11 includes pulley 11a and string 11b which extends from pulley 11a through guide hole 16b in support 12 and is attached to plate 17. Persons of skill in the art will recognize that potentiometer 11 may be positioned such that guide hole 16b is not needed. For example, a second pulley may be used to offset the direct drop of string 11b to plate 17. Line 11e links potentiometer 11 to control panel 18 to enable information and control signals to pass between them.

Potentiometer 11 is used to measure the vertical translational distance plate 17 is moved into receptacle 20 during the compacting operation. When string 11b is pulled around pulley 11a from pulley 11a as plate 17 descends, the changing amount of voltage in potentiometer 11 is transmitted to control panel 18. Because the voltage change can be correlated to the length of string 11b at the end of a particular descent of plate 17, the length of the descent can be recorded and/or stored in control panel 18. As trash accumulates in receptacle 20, the length of descent of plate 17 gradually decreases. When a predetermined minimum descent is measured, e.g., 3 inches, meaning device 14 can only move plate 3 inches or less below the upper edge of receptacle 20, linear actuator 15 can be locked out or prevented from operating by the programming of control panel 18 until receptacle 20 is emptied and replaced and compactor 10 is reset automatically or by an operator. String 11b may be an actual string, or it may be a cord, filament, or other material with suitable flexibility and strength to wind on pulley 11a and be unwound by the force of descending linear actuator 15. A suitable potentiometer is Model NTE-502-0106 from Radio Equipment Corp. Buffalo, N.Y. with retractable reel by ACCO Brand, Lincolnshire, Ill.

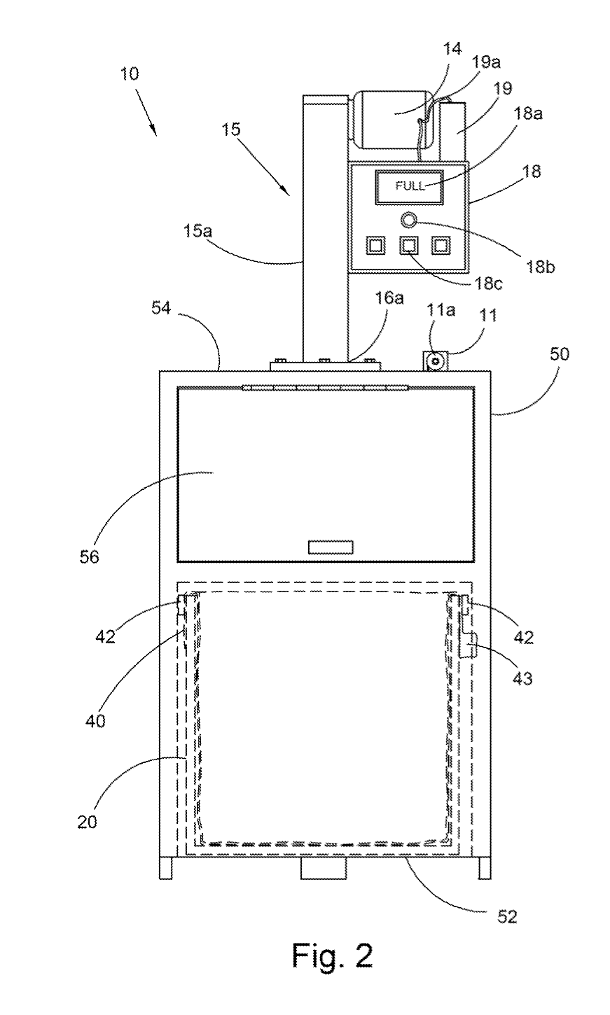

FIG. 2 is a front view of compactor 10 showing it enclosed in a housing 50. In one embodiment, housing 50 is a shell placed over all or part of compactor 10. It can be attached to frame 30 with screws, rivets, and other suitable fasteners including adhesives. Inlet door 56 is located below support 12 and/or upper edge 54 of housing 50. In a preferred embodiment, the upper edge of receptacle 20 (shaded in FIG. 2) is below the lower edge of door 56 to ensure trash is dropped into the inside of receptacle 20. Alternatively housing 50 may be built in such a way as to support linear actuator 15 on upper wall 54 and trash receptacle 20 on housing floor 52 without using a supporting frame 30.

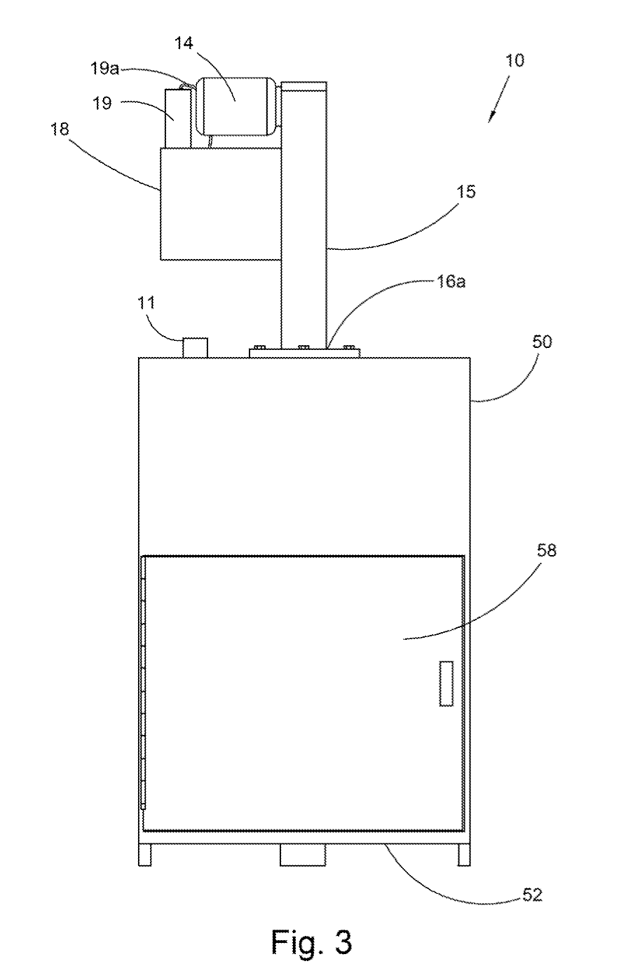

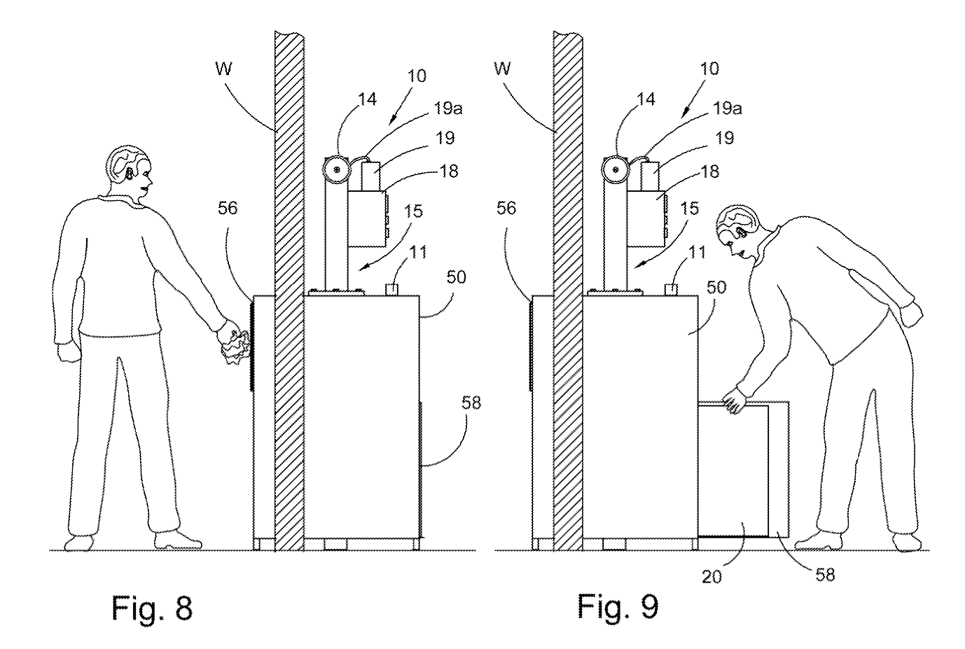

FIG. 3 is a rear view of compactor 10 showing the outlet door 58 (“door 58”) preferably located below the lower level of the opening for inlet door 56. Outlet door 58 is sized to allow receptacle 20 to pass through the door opening so as to remove fill receptacles 20 and position empty receptacles 20 into compactor 10. Preferably, inlet door 56 and outlet door 58 are on opposite sides of compactor 10. This preferred configuration provides the advantage of enabling compactor 10 to be built within or surrounded by a wall or barrier to allow an individual to deposit trash on one side of a barrier while the receptacles 20 are removed and replaced on the opposite side out of the view of the individual users. This also allows linear actuator 15 to operate out of the sight of individual users. FIGS. 8 and 9, respectively, depict this preferred embodiment showing a user depositing trash into inlet door 56 on one side of wall W and an operator removing receptacle 20 from the compactor out of outlet door 58 on the other side of wall W. In the preferred embodiment shown, device 14 and linear actuator 15 are positioned on the same side of wall W as outlet door 58. In this way, the operating mechanisms of compactor 10 and the actual removal of trash are hidden from public view providing a safer and more pleasing environment. However, doors 56 and 58 may be positioned on the same side of housing 50 or be positioned on housing 50 in other configurations without impairing the operation of compactor 10.

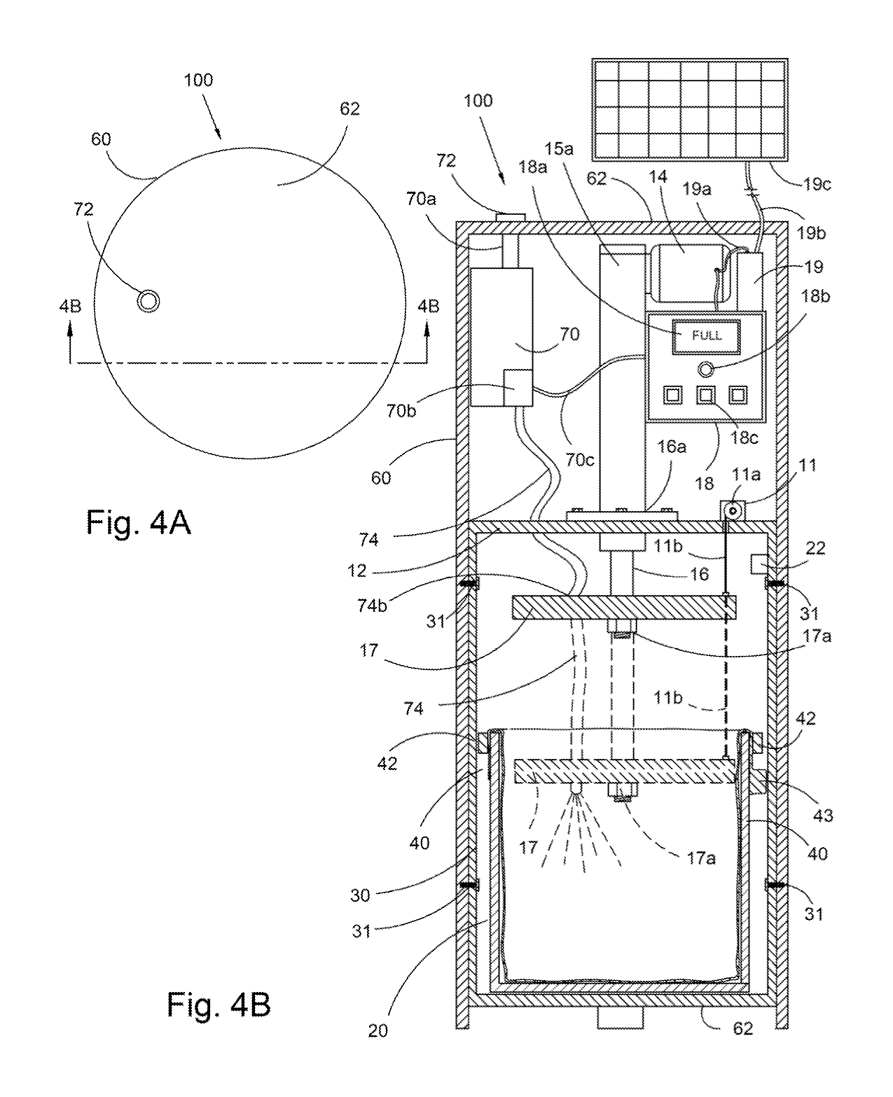

In an alternate embodiment, FIG. 4A is a top view of trash compactor 100 including housing 60 showing upper surface 62 of housing 60 and opening 72 defined by upper surface 62. Opening 72 leads to container 70 (not seen in FIG. 4A) which holds a wetting solution as described below. In this embodiment, housing 60 will be seen to enclose compactor 100 including flame 30, linear actuator 15, device 14, and control panel 18.

FIG. 4B is a schematic cross section of the alternate embodiment of compactor 100 seen in FIG. 4B in which housing 601 encloses all of compactor 100. Frame 30 is attached to housing 60 by screws 31 and supports housing 60. Container 70 is attached to an interior surface of housing 60 and configured to receive a tube 70a that extends from opening 72. Container 70 may also be attached to frame 30 in all embodiments. Tube 74 extends from container 70 through opening 17a in plate 17. Container 70 holds a wetting agent that can be sprayed or otherwise deposited onto the trash when plunger 16 and attached plate 17 are lowered into receptacle 20 to compact deposited trash. It has been discovered that wetting the trash during compacting prevents or reduces the tendency of some compacted trash, such as paper, STYROFOAM® plastic and other materials, to recoil after crushing, thereby increasing the total amount of trash that can be deposited into receptacle 20 before it is filled. A preferred example of a wetting agent is THICK-IT® thickener from Precision Foods, Inc., St. Louis, Mo., which is a mixture of food starch and maltodextrin mixed with water. The thickener can be mixed in a ratio of 1-4 tbsp. per 4 fluid ounces of water depending on the desired viscosity of the wetting agent. In an alternative embodiment, the wetting agent may be a mixture of glycerine and water again with the ultimate percentage of glycerine depending on the desired viscosity. The wetting agent may be delivered through tube 74 by a pump 70b controlled by control panel 18 through control link 70c. Container 70 and/or pump 70b may also be supported by frame 30. As seen in FIG. 4B, tube 74 is preferably long enough to reach to the full extended length of plunger 16 and plate 17, but also flexible to coil easily when linear actuator 15 is retracted.

FIG. 4B also depicts the use of at least one solar panel 19c to recharge battery 19. Cable 19b connects battery 19 with solar panel(s) 19c. This embodiment allows for placement of compactor 100 in a stand-alone position lacking power lines while removing the necessity of changing batteries or recharging by some other means. It also has the advantage of removing plug-in cords which can cause a hazard in public venues such as airports and malls.

Although control panel 18 is depicted as inside housing 60, it will be recognized by persons having skill in the art that control panel 18 may be positioned remotely outside housing 60 with suitable control cables or wireless control transmitters and receivers operatively connected to device 14 and wetting agent pump 70b. If control panel 18 is located within housing 60, a door (not shown in FIG. 4B) may be included in housing 60 to provide user access to control panel 18. Simple power switches, e.g., on/off switches, may be positioned similarly in place of control panel 18.

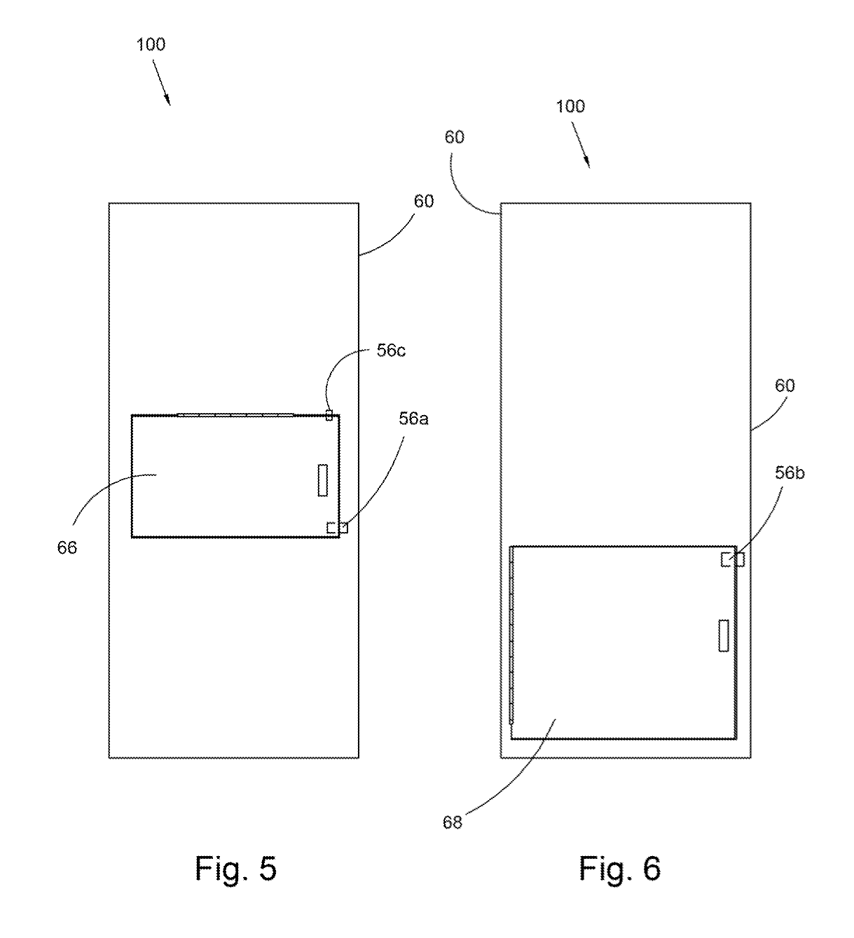

FIG. 5 is a front view of the embodiment shown in FIG. 4B depicting inlet door 66, while FIG. 6 is a rear view showing outlet door 68 sized to receive and remove receptacle 20. FIGS. 5 and 6 together depict a preferred embodiment in which inlet door 66 and outlet door 68 are on opposite sides of housing 60 with inlet door 66 higher on housing 60 than outlet door 68. It will be recognized that inlet doors 66 and outlet doors 68 may be positioned at different heights and different sides of housing 60 without impairing the operation of compactor 100.

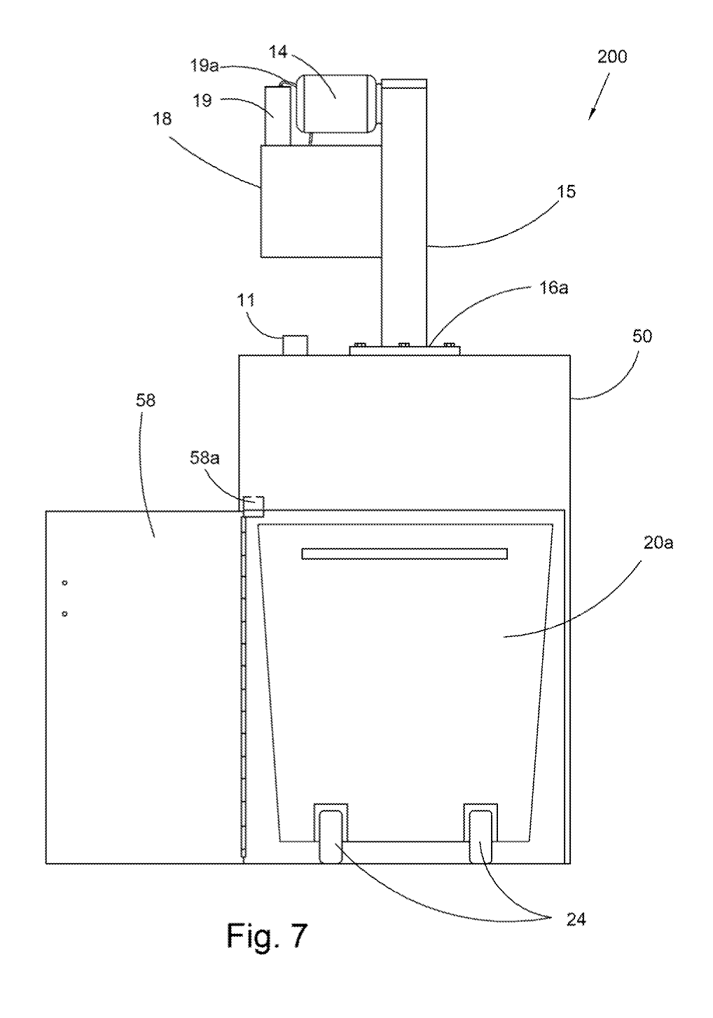

FIG. 7 is a rear view of trash compactor 200 which is another alternate embodiment of the trash compactor of the present invention. Housing 50 includes an alternate embodiment of outlet door 58 that extends to the bottom edge of housing 60. This configuration accommodates wheeled trash receptacle 20a having wheels 24. It will be recognized that wheels 24 may be replaced equivalently by other rolling means such as, for example, casters and rollers.

Control panel 18, such Model 1606-XLP manufactured by Allen Bradley, includes at least a programmable logic control (PLC), a circuit breaker and appropriate relays. Functionally attached to control panel 18 are door locks, such as solenoid-activated door locks and one or more swing switches 56c (“switches 56c”). Switches 56c are arranged to count the number of times inlet door 56, 66, is opened to deposit trash. Electric eye(s) 22 may also be used to detect a predetermined number of times inlet door 56 is opened to deposit trash. In a second alternate embodiment, compactor 100 may be operated on a time basis such that a timer activates plunger after a predetermined period of time, e.g., every three hours. An external timer may be used or control panel 18 may be equipped with a timer.

When the predetermined time or number of door openings is reached, door locks 56a and 58a lock both inlet door 56 and outlet door 58, respectively, white device 14 moves linear actuator 15 into receptacle 20. Plunger 16 is lowered into receptacle 20 with plate 17 crushing deposited trash. Preferably, plate 17 is lowered only a predetermined maximum distance which is less than the distance to the bottom of receptacle 20 or the length of plunger 16. This prevents plate 17 and plunger 16 from being tilted out of alignment by a rigid piece of trash such as, for example, a rod, cable spool, or glass bottle. A typical clearance distance is about 12 inches from the bottom of receptacle 20. After plunger 16 is retracted back to the home position (above the upper edge of upper door 56), locks 56a and 58a are unlocked.

Control panel 18 is programmed to measure the force used by device 14 to compress the trash. After a preset maximum force is reached, device 14 retracts the plunger/plate assembly out of receptacle 20 to its “home” position. The compacting force may range from 120-850 lbs. although the range may extend higher or lower depending on the type of trash being processed. In one embodiment, linear actuator 15 uses about 400 lbs, of force to compact deposited trash. Finally, when plate 17 can be lowered only a certain minimum distance, e.g., 3 inches, into receptacle 20 due to resistance from accumulated deposited trash, receptacle 20 is sensed as full. Preferably, potentiometer 19 discussed above is used to measure the travel distance of plunger 16. In other embodiments, electric eyes 22 or other sensors known in the art can be used to measure the distance the plunger is moved before maximum crushing force is attained. A “full” indicator such as, for example, a text field 18a or light 18b, activates and inlet door 56 is locked using lock 56a to prevent additional trash deposits. After receptacle 20 is emptied or replaced, an operator can reset control panel 18 or it may automatically reset to allow inlet door 56 to be opened.

Thus it is seen that the objects of the invention are efficiently obtained, although changes and modifications to the invention should be readily apparent to those having ordinary skill in the art, which changes would not depart from the spirit and scope of the invention as claimed.

We claim:

1. A trash compactor comprising:
a removable trash receptacle having an upper edge;
a housing, said housing having a floor, a support extending across and supported by said housing, an inlet door located above said upper edge of said trash receptacle when said trash receptacle is positioned within said housing and an outlet door sized to enable said trash receptacle to pass through said lower door;
a linear actuator secured to said support, said linear actuator comprising a plunger arranged for vertical translational movement;
a plate secured to a distal end of said plunger and operatively arranged to compact trash within said trash receptacle;
a device operatively arranged to power said linear actuator and impart a motive force to said plunger to move said plate within said receptacle; and,
a control panel operatively arranged to control said device.

2. The trash compactor as recited in claim 1 further comprising a distance measuring instrument, said measuring instrument arranged to measure the length of said vertical translational movement into said removable trash receptacle.

3. The trash compactor as recited in claim 2 wherein said distance measuring instrument is a potentiometer.

4. The trash compactor as recited in claim 1 wherein said trash receptacle is configured to snugly receive said plate.

5. The trash compactor as recited in claim 1 wherein said support defines a guide hole sized to receive said plunger.

6. The trash compactor as recited in claim 1 wherein said inlet door and said outlet door are on opposite sides of said housing.

7. The trash compactor as recited in claim 1 further comprising a liner removably attached to said receptacle.

8. The trash compactor as recited in claim 7 wherein said liner attachment is a flange.

9. The trash compactor as recited in claim 7 further comprising a first container attached to said liner wherein said first container holds a deodorizer and/or an animal repellant.

10. The trash compactor as recited in claim 1 further comprising a second container attached to said housing and having a tube extending from said second container to said receptacle.

11. The trash compactor as recited in claim 10 wherein said second container holds a wetting agent.

12. The trash compactor as recited in claim 1 wherein said device is an electric motor.

13. The trash compactor as recited in claim 12 wherein said electric motor is a direct current motor powered by batteries.

14. The trash compactor as recited in claim 14 wherein said batteries are recharged using at least one solar panel.

15. The trash compactor as recited in claim 1 wherein said device is a hydraulic pump.

16. The trash compactor as recited in claim 1 wherein said device is a pneumatic pump.

17. The trash compactor as recited in claim 1 further comprising an interlock system, wherein said interlock system locks said inlet door during the movement of said plunger.

18. The trash compactor as recited in claim 17 wherein said interlock system locks said outlet door during the movement of said plunger.

19. The trash compactor as recited in claim 17 wherein said interlock system locks said inlet door when said receptacle is full.

20. The trash compactor as recited in claim 1 further comprising a swing switch to count the number of openings of said inlet door.

21. The trash compactor as recited in claim 1 further comprising a timer wherein said timer activates said device at one or more predetermined intervals.

22. The trash compactor as recited in claim 2 wherein said trash compactor is arranged to lock said inlet door after a downward vertical translational movement of said plate attached to said plunger is approximately less than or equal to a predetermined minimum distance measured by said measuring instrument.

23. The trash compactor as recited in claim 22 wherein said compactor activates an indicator to signify said receptacle is full.

24. The trash compactor as recited in claim 1 wherein said trash receptacle includes at least two wheels.

25. The trash compactor as recited in claim 1 further comprising a frame, said frame supporting said housing.

26. The trash compactor as recited in claim 25 wherein said support extends across at least one upper edge of said frame and supports said linear actuator thereby.

27. The trash compactor as recited in claim 25 further comprising a second container attached to said outer frame and having a tube extending from said second container to said receptacle.

28. The trash compactor as recited in claim 27 wherein said second container holds a wetting agent.

29. The trash compactor as recited in claim 1 wherein the force of said plate on trash deposited in said receptacle during a downward translational movement of said plunger ranges from 120-850 pounds.

30. The trash compactor as recited in claim 29 wherein said force is approximately 400 pounds.

31. A trash compactor comprising:
a removable trash receptacle having an upper edge;
a frame having a support extending across at least one upper edge of said outer frame;
a linear actuator supported by said support and including a plunger and a plate attached to said plunger;
a device operatively arranged to power said linear actuator and impart a vertical translational movement to said plunger to move said plate within said receptacle; and,
a control panel operatively arranged to control said device.

32. The trash compactor as recited in claim 31 wherein said support defines a guide hole sized to receive said plunger.

33. The trash compactor as recited in claim 31 wherein said control panel controls power delivered to said device.

34. The trash compactor as recited in claim 31 further comprising a distance measuring instrument, said distance measuring instrument arranged to measure the length of a downward vertical translational movement into said removable trash receptacle.

35. The trash compactor as recited in claim 34 wherein said distance measuring instrument is a potentiometer.

36. The trash compactor as recited in claim 31 further comprising a housing wherein said housing is supported by said frame and an inlet door and an outlet door are positioned on said housing.

37. The trash compactor as recited in claim 36 wherein said inlet and outlet doors are positioned on opposite sides of said housing.

38. The trash compactor as recited in claim 36 wherein said inlet door is located above said upper edge of said trash receptacle when said trash receptacle is positioned within said frame.

39. The trash compactor as recited in claim 31 wherein the force of said plate on trash deposited in said receptacle during a downward translation movement of said plunger ranges from 120-850 pounds.

40. The trash compactor as recited in claim 39 wherein said force is approximately 400 pounds.

41. The trash compactor as recited in claim 31 wherein said device is an electric motor.

42. The trash compactor as recited in claim 41 wherein said electric motor is a direct current motor powered by batteries.

43. The trash compactor as recited in claim 42 wherein said batteries are recharged using at least one solar panel.

44. The trash compactor as recited in claim 31 wherein said device is a hydraulic pump.

45. The trash compactor as recited in claim 31 wherein said device is a pneumatic pump.

46. A method of compacting trash comprising utilizing a trash compactor including:
a removable trash receptacle having an tipper edge;
a housing, said housing having a floor, a support extending across and supported by said housing, an inlet door located above said upper edge of said trash receptacle when said trash receptacle is positioned within said housing and an outlet door sized to enable said trash receptacle to pass through said lower door;
a linear actuator secured to said support, said linear actuator comprising a plunger arranged for vertical translational movement;
a plate secured to a distal end of said plunger and operatively arranged to compact trash within said trash receptacle;
a distance measuring instrument arranged to measure the length of said vertical translational movement into said removable trash receptacle;
a device operatively arranged to power said linear actuator and impart a motive force to said plunger to move said plate within said receptacle;
a container holding a wetting solution, and,
a control panel operatively arranged to control said device.
said method comprising:
a. positioning said removable trash receptacle in said housing under said linear actuator;
b. lowering said device to move said plate into said receptacle in a downward vertical translational movement;
c. measuring the distance said plate moves into said receptacle;
d. spraying a wetting solution into said receptacle; and,
e. raising said plate to a position above said upper edge of said receptacle in an upward translational movement.

47. The method as recited in claim 46 further comprising locking said inlet door before lowering said plate.

48. The method as recited in claim 46 further comprising unlocking said inlet door after raising said plate.

49. The method as recited in claim 46 further comprising repeating steps a-e.

50. The method as recited in claim 46 wherein said measurement is approximately less than or equal to a predetermined minimum downward vertical distance and wherein said inlet door is locked.

51. The method as recited in claim 46 wherein said distance measuring instrument is a potentiometer.

52. The method as recited in claim 46 wherein said downward vertical translational movement has a force ranging from 120-850 pounds.

53. The method as recited in claim 52 wherein said force is approximately 400 pounds.

54. The method as recited in claim 46 wherein said trash compactor further comprises a frame, said frame supporting said housing and wherein said support extends across at least one upper edge of said frame and supports said linear actuator thereby.

55. The method as recited in claim 46 wherein said housing is replaced by a frame, said frame having a support extending across at least one upper edge of said outer frame and supports said linear actuator thereby.
